(19) United States
(12) Patent Application Publication
(10) Pub. No.: US 2013/0025589 A1
(43) Pub. Date: Jan. 31, 2013

(54) HOOD ASSEMBLY FOR USE WITH A PROTECTIVE SUIT

(71) Applicants: William Darvill, Clevedon (GB); Matthew James Hodgson, Ramsbury (GB)

(72) Inventors: William Darvill, Clevedon (GB); Matthew James Hodgson, Ramsbury (GB)

(73) Assignee: AVON POLYMER PRODUCTS LIMITED, Wiltshire (GB)

(21) Appl. No.: 13/577,720

(22) PCT Filed: Feb. 10, 2011
(86) PCT No.: PCT/GB2011/000179

§ 371 Date: Oct. 16, 2012

(30) Foreign Application Priority Data
Feb. 11, 2010 (GB) 1002333.1

(51) Int. Cl. A62B 7/10; A62B 17/04

(52) U.S. Cl. 128/201.25; 2/410

(57) ABSTRACT

A hood assembly for a protective suit has a hood (41) and a seal (10). The seal extends about the rim of the hood and comprises a sheet composed partly or entirely of resilient material. The sheet is provided with a pocket (14). The pocket (14) has an inner layer (16) for contacting a contoured surface and an outer layer (18), separated by a filler medium (22). The outer layer is curved about the filler medium when no stretching force (26) is applied to the sheet, and as the sheet is subjected to a stretching force a first component of the stretching force is transmitted along the outer layer. As the sheet is subjected to a stretching force the curvature of the outer layer is reduced, so that a pressing force (28) is transmitted from the outer layer, through the filler medium, onto the inner layer. The pressing force presses the inner layer against the contoured surface, so as to reduce fluid flow between the inner layer and the contoured surface.

### FIELD OF THE INVENTION

The present invention relates to hood assemblies for protective suits, in particular to hood assemblies that are for wearing with a respiratory mask.

### BACKGROUND TO THE INVENTION

It is known to use protective suits to protect individuals from exposure to e.g. chemical, biological, radiological, or nuclear hazards. Such suits generally include a hood for pulling over the wearer's head.

The suits are generally worn in conjunction with respiratory masks. Typically, the rim of the hood is provided with a seal, e.g. a rubber sheet, that follows the circumference of the rim, so as to provide a closed loop, and that also extends in a forward direction from the rim of the hood.

The seal is for securing the hood to the outer perimeter of the respiratory mask. The circumference of the rubber sheet in its unstretched state is less than the circumference of the corresponding portion of the respiratory mask. Thus when the rubber sheet is fitted about the respiratory mask, it is stretched around it, so that fluid flow between the inner surface of the rubber sheet and the outer surface of the respiratory mask is inhibited.

Thus, when the hood and mask are in place on the wearer, the flow of air from the external atmosphere into the protective suit is reduced. Such fluid flow might otherwise comprise the internal atmosphere of the protective suit.

However, this seal may be less effective in cases where the rubber sheet is stretched around a contoured surface, i.e. a surface having regions that are raised and lowered relative to each other, e.g. having peaks and troughs. This is because the rubber sheet will tend to be supported at discrete portions of its circumference by the raised regions of the contoured surface. The intervening sections of the sheet will tend to be held away from the lowered regions of the surface, due to the tension in the sheet. Thus, the intervening sections of the sheet will effectively bridge adjacent raised regions of the surface, rather than following closely the surface of the element to be sealed.

In this case, fluid flow may still take place along the recesses (e.g. the troughs) of the surface to be sealed, and the efficacy of the seal is reduced.

Examples of a contoured surface may be found in a number of different areas of a respiratory mask, depending e.g. on the design of the mask and the manufacturing processes used. For example, the area of the mask that is for contacting the region of the wearer's face between the eyebrow and the jaw line may provide a contoured surface.

Depending on the design of the mask and the manufacturing processes used, contoured surfaces may also be found on the portion of the mask corresponding to the chin of the wearer.

In fact, a contoured surface may be found at any point around the circumferential area of a respirator mask, depending e.g. on the design of the mask (and the resulting moulded shape), and/or on the head/face/neck shape of the wearer. For example, recesses may result from the shape of the wearer's head, e.g. from the position of the wearer's cheekbone or jawbone.

Tension in the harness of the respiratory mask (i.e. the strap passing around the back of the head of the wearer) may also result in portions of the respirator mask becoming distorted, so that they have a contoured shape.

Such contoured (i.e. uneven) portions cannot normally be followed closely by the rubber sheet that is provided on the hood for sealing against the mask.

Thus air may flow along the recesses associated with the contoured surfaces, and this may compromise the internal atmosphere of the protective suit.

### SUMMARY OF THE INVENTION

Therefore, at its most general, the present invention may provide a seal that extends along the rim of a hood that is for use with a protective suit. The seal may be used to secure the hood to a contoured surface, such as a respiratory mask. The seal includes a pocket that deforms asymmetrically when the seal is stretched, such that the filler medium in the pocket is urged in a radially inward direction of the rim of the hood.

Thus, it may be possible to inhibit fluid flow along a recess in the contoured surface, by positioning the pocket at the site of the recess, so that the filler medium is urged into the recess when the seal is stretched.

Thus, in a first aspect, the present invention may provide a hood assembly for a protective suit, comprising a hood and a seal, the seal extending about the rim of the hood and comprising a sheet composed partly or entirely of resilient material, the sheet being provided with a pocket, the pocket having an inner layer for contacting the respiratory mask and an outer layer, the inner and outer layers being separated by a filler medium that is configured to transmit force from the outer layer to the inner layer, the pocket being configured such that (i) the outer layer is curved about the filler medium when no stretching force is applied to the sheet, and (ii) as the sheet is subjected to a stretching force: a first component of the stretching force is transmitted along the outer layer, the first component of the stretching force being greater than any component of the stretching force that is simultaneously transmitted along the inner layer, and the curvature of the outer layer is reduced, so that a pressing force is transmitted from the outer layer, through the filler medium, onto the inner layer, the pressing force pressing the inner layer against the respiratory mask, so as to reduce fluid flow between the inner layer and the respiratory mask.

The configuration of the pocket to allow the stretching force to be transmitted along the inner and outer layers in unequal amounts (including the case where no stretching force is transmitted along the inner layer) results in an asymmetrical deformation of the pocket when the seal is stretched. That is, the higher magnitude of the stretching force transmitted along the outer layer causes the outer layer, as it straightens, to exert a greater pressure on the filler medium than any opposing pressure exerted by the inner layer.

Thus, by positioning the pocket adjacent to a recess associated with a contoured surface, the inner layer may be urged against the recess upon stretching of the seal, so as to create intimate contact between the inner layer and the recess.

In general, the sheet comprised within the seal is composed entirely of a resilient material. The resilient material may be e.g. rubber.

Typically the inner layer of the pocket is joined to the rest of the seal via a connecting section provided by the outer layer. Effectively, in this case, the inner layer acts to secure the filler medium to the outer layer, and hence to the rest of the seal.

In the case that the pocket is configured to be located at an edge of the seal, the inner layer of the pocket may be provided by a portion of the sheet that is folded against the outer layer of the pocket. That is, the inner and outer layers may be provided by two portions of the sheet, the sheet being folded so that these two portions oppose each other.

However, the pocket may have other configurations, for example, the inner layer may be a discrete component that is bonded to the sheet about the boundary of the pocket.

The pocket is configured such that when the sheet is stretched, either no stretching force is transmitted along the inner layer, or alternatively, the component of the stretching force transmitted along the inner layer is less than the component of the stretching force that is transmitted along the outer layer.

This configuration may ensure that the pressing force transmitted from the outer layer to the filler medium when the sheet is stretched is greater than any opposing pressing force transmitted from the inner layer onto the filler medium.

This configuration may be achieved in a number of different ways. For example, in certain cases, the inner layer is connected to the rest of the seal through bonding about a region defining the boundary of the pocket. Such bonding may be a bond that has been applied to the inner and outer layers to join them together (e.g. through stitching), but may also include intrinsic bonding (e.g. where the inner and outer layer are joined at a fold in the sheet).

In these cases, the unequal transmission of the stretching force along the inner and outer layers may be achieved by ensuring that one or more paths are provided from the filler medium to the exterior of the pocket, the inner and outer layers being non-bonded to each other along the length of each of the one or more paths. Thus the bonding along the boundary of the pocket is incomplete, i.e. the bond does not extend entirely around the pocket, and so does not form a closed loop.

That is, in this case, the inner layer and outer layer are only bonded along a discrete portion or portions of the pocket boundary. Effectively, therefore, at certain sections of the boundary of the pocket, there are gaps in the bond, where the inner and outer layers are in abutting non-bonded contact. Thus, the filler medium is not completely encapsulated in the pocket, i.e. there are one or more breaks in the encapsulation. This arrangement allows a stretching force to be transmitted across the outer layer of the pocket, while little, if any of the force is transmitted across the inner layer, due to the incomplete bonding of the inner and outer layers.

In general, in this case, the non-bonded portions of the pocket boundary are arranged to extend in the direction of the stretching force i.e. to extend in a direction along the circumferential direction of the rim of the hood. That is, the inner and outer layers of the pocket are bonded in preference at those portions of the pocket boundary that are arranged to extend transversely to the direction of stretching. Effectively, therefore, at least one of the one or more paths (along the length of which the inner and outer layers are unbonded to each other) extends in a direction transverse to the circumferential direction of the rim of the hood.

In alternative embodiments, the difference in the stretching force transmitted across the inner and outer layers is achieved by providing an inner layer that is thinner and/or has a lower elastic modulus than the outer layer.

In general, it is desirable for the outer layer to have a greater degree of curvature than the inner layer, when the seal is in its unstretched state (i.e. when no stretching force is being applied to the seal). Thus, the pocket is asymmetrical. The low degree of curvature of the inner layer provides the seal with a relatively smooth surface about its inner circumference that allows it to be fitted easily about the mask.

However, in certain embodiments, the pocket may be symmetrical, i.e. the inner and outer layers have the same degree of curvature when the seal is in the unstretched state.

In fact, in some embodiments, the inner layer may be “oversized” relative to the outer layer. That is, the degree of curvature of the inner layer may be greater than that of the outer layer, when no stretching force is being applied to the seal. Effectively, in this case, the distance across the pocket, from one portion of the boundary of the pocket to an opposed portion of the boundary is greater when measured along the inner layer of the pocket than when measured along the outer layer.

This embodiment provides a further example of an arrangement that allows the inner layer of the pocket to carry only a low proportion of the stretching force (compared to the outer layer) when the sheet of the seal is stretched. In this case, it is not necessary for the inner layer to be e.g. thinner or have a lower elastic modulus.

The filler medium may be any kind of medium that is capable of transmitting force. The filler medium may comprise an airbag, i.e. air trapped within an enclosing liner. The enclosing element may be a shell made of e.g. polyurethane or another compliant polymer. Typically, the air trapped within the enclosing liner is at atmospheric pressure when the seal is in its unstretched state.

In other cases, the filler medium may be a liquid or a solid. For example, the filler medium may include a low hardness solid, e.g. a solid having a hardness lower than 20 Shore A. Examples of such solids include thermoplastic polymers such as silicones, polyurethanes, thermoplastic elastomers (sometime referred to as thermoplastic rubbers), and SBS polymers (i.e. styrene-butadiene-styrene block copolymers).

Alternatively, the filler medium may include a liquid or a gel, such as a silicone gel, or an oil. Typically, a liquid selected for use as a filler medium will have a high viscosity.

Preferably, the filler medium is soft and compliant, so that it changes shape readily in response to the changing shape of the pocket, as the seal is stretched. A soft and compliant medium is any medium that has a low resistance to shape change, i.e. one that yields easily to an external applied force. The filler medium may comprise any gaseous, liquid or solid medium that displays this low resistance to shape change, including, for example, formable or mouldable materials.

In certain cases, the filler medium may be both compliant and resilient, so that it resumes its initial shape when the seal is no longer subjected to a stretching force.

The hood and seal of the first aspect of the invention may be provided in the disassembled state, for subsequent assembly.

Therefore, in a second aspect, the present invention may provide a kit of parts comprising a hood for a protective suit and a seal for fitting about the rim of the hood, wherein the seal comprises a sheet composed partly or entirely of resilient material, the sheet being provided with a pocket, the pocket having a first layer, a second layer, and a filler medium disposed between the first and second layers, the filler medium being configured to transmit force from the first layer to the second layer, the pocket being configured such that (i) the first layer is curved about the filler medium when no stretching force is applied to the sheet, and (ii) as the sheet is subjected to a stretching force: a first component of the stretching force is transmitted along the first layer, the first component of the stretching force being greater than any component of the stretching force that is simultaneously transmitted along the second layer, and the curvature of the first layer is reduced, so that a pressing force is transmitted from the first layer, through the filler medium, onto the second layer.

When the kit of parts is assembled, such that the seal extends around the rim of the hood, the seal is oriented such that the second layer is positioned for contacting the contoured surface against which the hood is to be secured, while the first layer faces away from this surface. Thus, the first layer effectively provides an outer layer of the pocket, while the second layer provides an inner layer.

When assembled, the kit of parts of the second aspect of the invention may exhibit any or all of the preferred features of the hood assembly of the first aspect of the invention, to the extent that these are combinable.

The hood assembly of the first aspect of the invention may be provided together with a mask (e.g. a respiratory mask).

Therefore, in a third aspect, the present invention may provide a kit of parts comprising: a hood assembly according to the first aspect of the invention; and a mask, wherein the seal of the hood assembly is configured to seal the hood assembly about the mask.

In this case, the seal typically extends about the rim of the hood such that the pocket is positioned to contact a portion of the mask having a contoured surface. This portion of the mask may be, e.g. the portion that is for contacting the region of the wearer's face between the eyebrow and jawline.

### BRIEF DESCRIPTION OF THE DRAWINGS

Embodiments of the invention will now be described by way of example with reference to the accompanying drawings in which:

FIG. 1 shows a section view of a seal according to a first embodiment of the invention, in an unstretched state.

FIG. 2 shows the seal of FIG. 1 in a stretched state.

FIG. 3 shows a perspective view of a seal according to a second embodiment of the invention, stretched around a respiratory mask.

FIG. 4 shows a perspective section view of the seal of FIG. 3, in an unstretched state, and adjacent to the respiratory mask.

FIG. 5 shows a perspective section view of the seal of FIG. 3, in a stretched state, and adjacent to the respiratory mask.

### DETAILED DESCRIPTION; FURTHER OPTIONS AND PREFERENCES

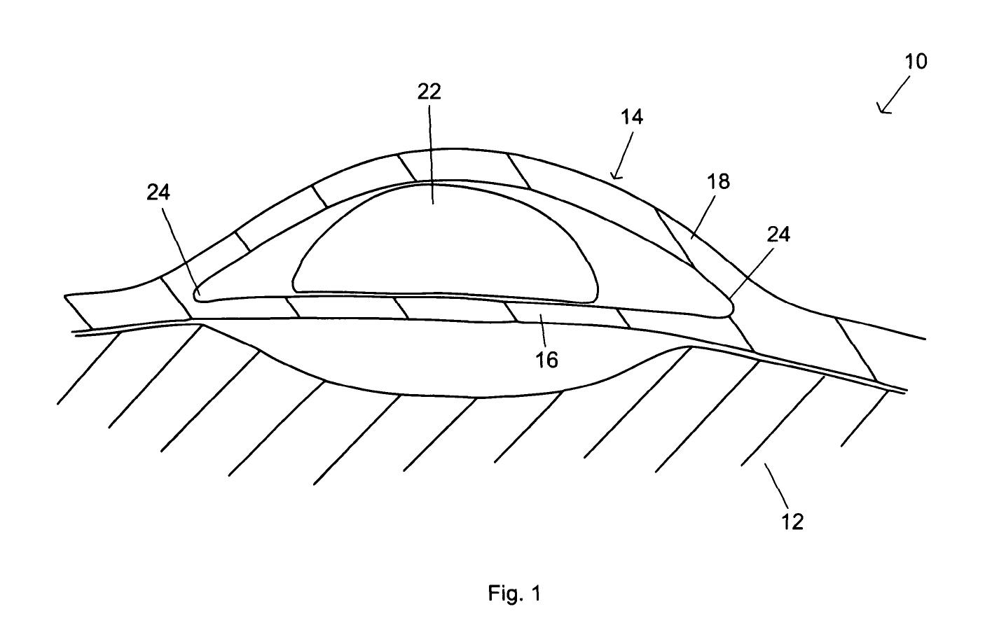

FIG. 1 shows a seal 10 in an unstretched state, in contact with a contoured surface 12. That is, the seal shown in FIG. 1 is not experiencing a stretching force. The seal 10 includes a sheet of resilient material, e.g. rubber, that extends around the rim of the hood of a protective suit (not shown). The sheet of resilient material has a pocket 14. The pocket 14 is made up of an inner layer 16 that contacts the contoured surface 12, and an outer layer 18 that is opposed to the inner layer 16. Between the inner layer 16 and the outer layer 18 of the pocket 14 is a filler medium 22.

The filler medium may be an airbag (e.g. air encapsulated in a polyurethane shell), a liquid, or a solid. Suitable solids include low hardness materials (e.g. materials having a hardness lower than 20 Shore A), such as thermoplastic elastomers (e.g. silicones, polyurethanes, and styrene-butadiene-styrene (SBS) polymers). Suitable liquids include oils (e.g. high-viscosity oils)and gels (e.g. silicone gels).

The inner and outer layers 16,18 are joined at the boundary of the pocket 14 (reference 24 in FIG. 1 shows portions of the boundary, as seen in the section view of the seal). The inner and outer layers 16,18 may be joined along the entire boundary of the pocket, so that the filler medium 22 is entirely encapsulated in the pocket 14. Alternatively, the inner and outer layers 16,18 may be joined only about a portion or portions of the boundary.

The outer layer 18 is curved about the filler medium 22, the degree of curvature of the outer layer 18 being greater than that of the inner layer 16, at least while the seal 10 is in its unstretched state.

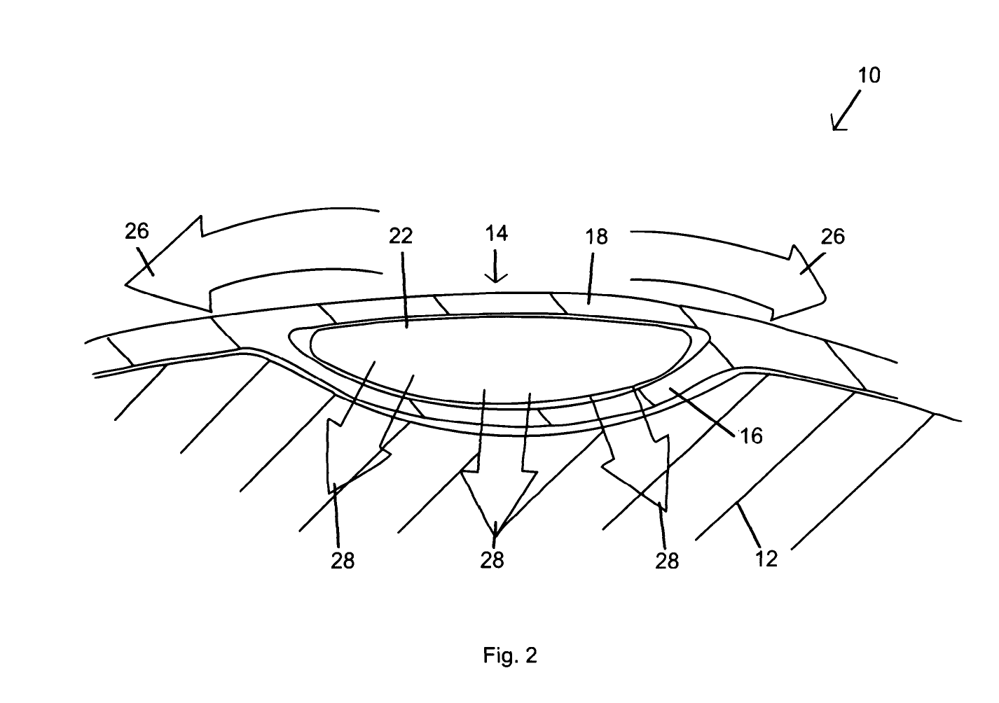

FIG. 2 shows the seal 10 of FIG. 1 in a stretched state. The seal 10 is subjected to a stretching force in a longitudinal direction of the pocket 14. The stretching force 26 causes the degree of curvature of the outer layer 18 to decrease, such that a pressing force 28 is exerted onto the filler medium 22, and then transmitted from the filler medium 22 onto the inner layer 16.

The pressing force 28 acts to press the inner layer 16 against the contoured surface 12, so as to reduce fluid flow between the inner layer and the contoured surface. In particular, the pressing force 28 acts to press the inner layer 16 into recesses in the contoured surface, so as to reduce the flow of fluid along these recesses.

In order for the degree of curvature of the outer layer 18 to decrease in response to the stretching force 26 and for the inner layer 16 to deform in response to the pressing force 28, the pocket 14 is configured such that either: (i) the stretching force 26 is transmitted entirely along the outer layer 18; or (ii) the component of the stretching force 26 that is transmitted along the inner layer 16 is less than the component that is transmitted along the outer layer 18.

This asymmetry in the transmission of the stretching force 26 along the inner and outer layers 16,18 may be achieved, e.g. by providing an inner layer 16 that is thinner and/or has a lower elastic modulus than the outer layer 18.

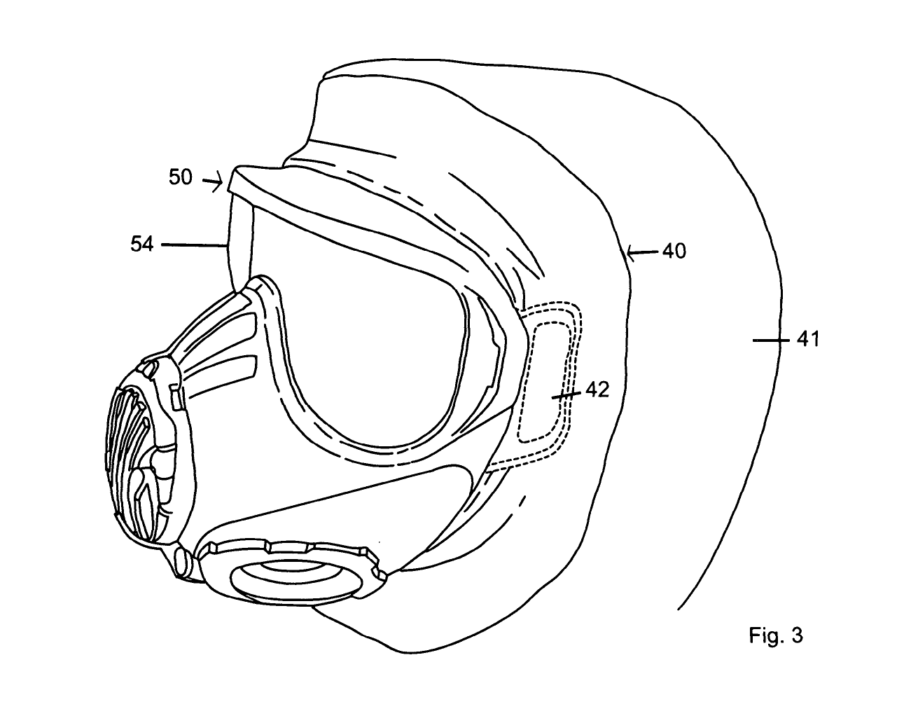

FIG. 3 shows a perspective view of a seal according to a second embodiment of the invention. The seal is shown in a position extended about a respiratory mask 50. In this case, the seal 40 is being used to secure the hood 41 of a chemical protection suit to the respiratory mask 50 so as to inhibit fluid entry into the chemical protection suit via the opening of the hood 41.

The seal 40 is attached to the rim of the hood 41 of a chemical protection suit and is provided as a closed loop for stretching around the wearer's head. The seal 40 includes a pocket 42 that is located so as to be positioned against the lateral extremity of the visor portion 54 of the mask.

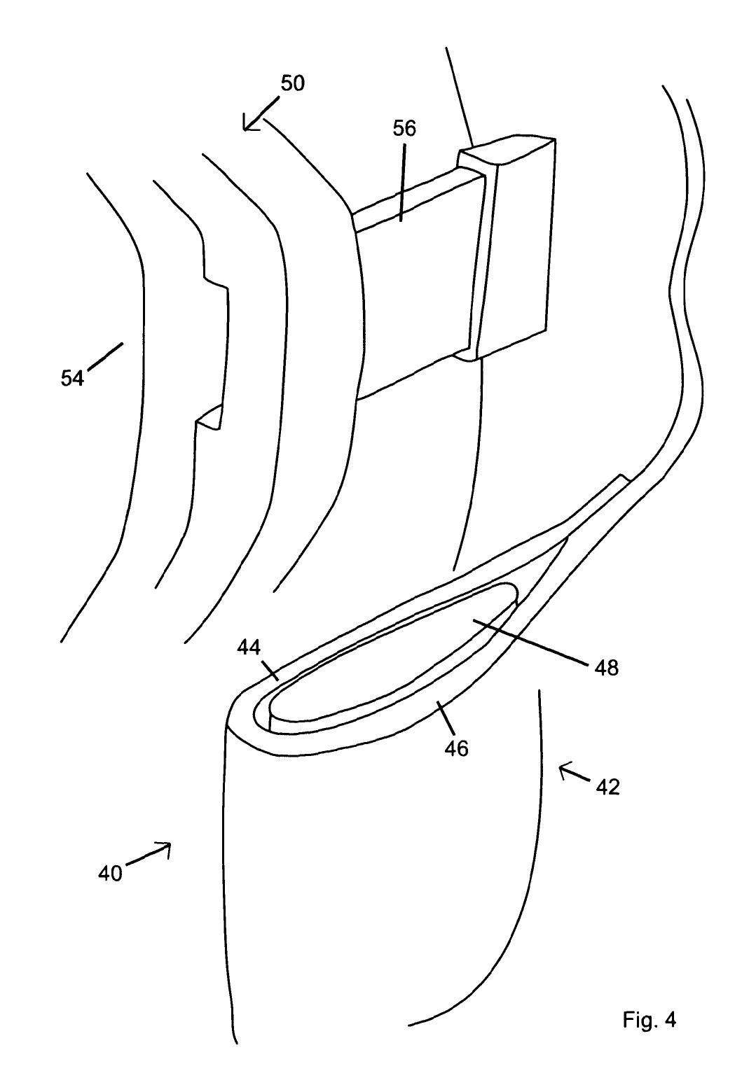

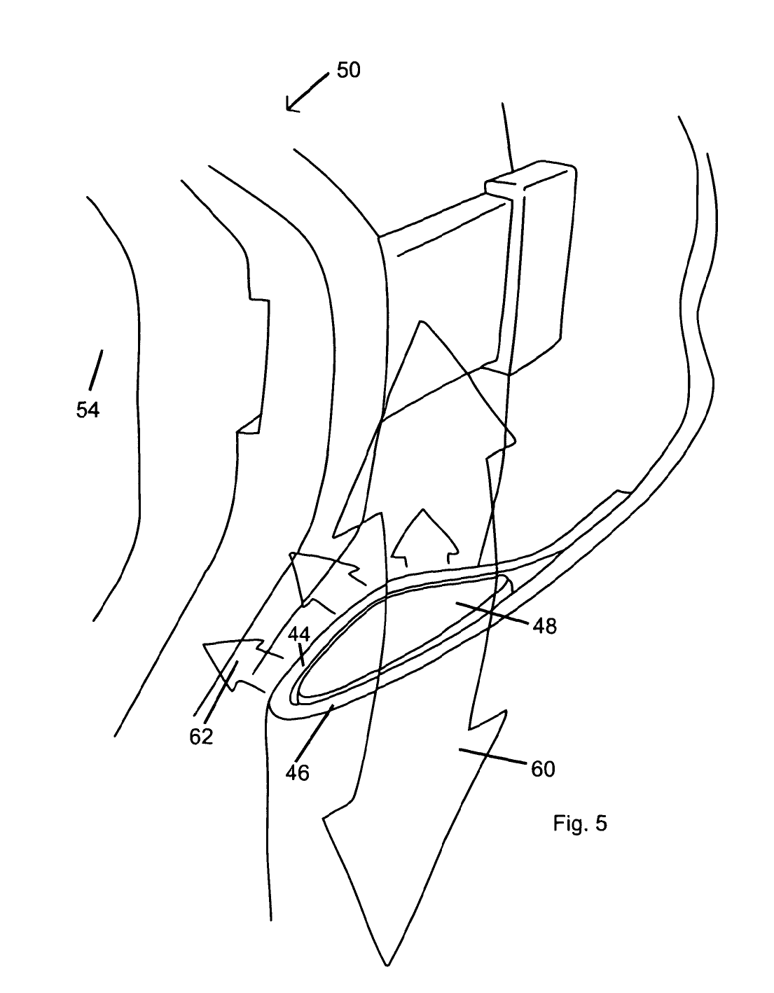

The pocket 42 is shown in more detail in FIGS. 4 and 5, which show perspective section views of the seal 40 in position against the lateral extremity of the visor 54. The lateral extremity of the visor 54 is connected to the harness 56 of the respiratory mask 50, the harness 56 securing the mask 50 to the wearer's head.

The region of the respiratory mask 50 that contacts the wearer's face between the eyebrow and jawline provides a contoured surface across which the seal 40 is required to be stretched. (This region is the portion of the mask 50 below the harness 56, as seen from the point of view of the wearer of the mask). Thus the pocket 42 is positioned to be located against or adjacent to this region of the respiratory mask 50, so as to reduce fluid flow along the recesses resulting from the contoured surface.

The pocket 42 has an inner layer 44, an outer layer 46 and a filler medium 48 disposed between the inner and outer layers.

FIGS. 4 and 5 show perspective section views of the seal 40 in the unstretched and stretched states respectively. In the stretched state, the seal 40 experiences a stretching force in a circumferential direction. The stretching force 60 causes the degree of curvature of the outer layer 46 of the pocket 42 to decrease, such that the outer layer 46 exerts a pressing force 62 against the filler medium 48, the filler medium 48 transmitting the pressing force to the inner layer 44 of the pocket 42. Thus, the inner layer 44 is pressed against the contoured surface of the mask 50 that corresponds to the portion of the wearer's face between the eyebrow and jawline.

By pressing the inner layer 44 against the recesses in the contoured surface, fluid flow along the recesses is reduced.

The pocket 42 is provided by a portion of the seal 40 that is folded so as to provide opposed inner and outer layers 44,46. The fold marking the boundary between the inner and outer layers 44,46 extends in a circumferential direction of the seal. Thus, one edge of the inner layer 44 is provided by the fold bounding the inner and outer layers 44,46. The remaining edges of the inner layer 44 are secured in part to the rest of the seal, along the boundary of the pocket 42.

By ensuring that the filler medium 48 is not completely encapsulated by the pocket 42, i.e. by ensuring that at some sections of the boundary of the pocket 42, the inner and outer layers 44,46 are unbonded, it is possible to provide a pocket in which a stretching force applied along a longitudinal direction of the pocket 42 (i.e. in a circumferential direction of the seal 40) is transmitted mostly through the outer layer 46, rather than the inner layer 44.

This helps to ensure that the degree of curvature of the outer layer 46 of the pocket decreases in response to the stretching force 60, and that the inner layer 44 deforms in response to the pressing force 62 generated by the decreased curvature of the outer layer.

Typically, the unbonded portions of the boundary of the pocket 42 extend in the direction of the stretching force 60, that is, in a circumferential direction of the seal 40. Those portions of the boundary of the pocket extending in a direction transverse to the force 60, i.e. transversely to the circumference of the seal, typically comprise bonded inner and outer layers.

The pocket 42 is shaped such that, at least in the unstretched state, the degree of curvature of the outer layer 46 is greater than that of the inner layer 44.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1. A hood assembly for a protective suit, comprising a hood and a seal, the seal extending about the rim of the hood and comprising a sheet composed partly or entirely of resilient material,
the sheet being provided with a pocket,
the pocket having an inner layer for contacting a contoured surface and an outer layer,
the inner and outer layers being separated by a filler medium that is configured to transmit force from the outer layer to the inner layer,
the pocket being configured such that:
(i) the outer layer is curved about the filler medium when no stretching force is applied to the sheet, and
(ii) as the sheet is subjected to a stretching force:
a first component of the stretching force is transmitted along the outer layer, the first component of the stretching force being greater than any component of the stretching force that is simultaneously transmitted along the inner layer, and
the curvature of the outer layer is reduced, so that a pressing force is transmitted from the outer layer, through the filler medium, onto the inner layer, the pressing force pressing the inner layer against the contoured surface, so as to reduce fluid flow between the inner layer and the contoured surface.

2. A hood assembly according to claim 1 wherein the inner layer of the pocket is joined to the rest of the seal via a connecting section provided by the outer layer.

3. A hood assembly according to claim 1, wherein the inner layer of the pocket is provided by a portion of the sheet that is folded against the outer layer.

4. A hood assembly according to claim 1, wherein one or more paths are provided from the filler medium to the exterior of the pocket, the inner and outer layers being non-bonded to each other along the length of each of the one or more paths, such that the filler medium is incompletely encapsulated.

5. A hood assembly according to claim 4, wherein at least one of the one or more paths extends in a direction transverse to the circumferential direction of the rim of the hood.

6. A hood assembly according to claim 1, wherein the inner layer is thinner than the outer layer.

7. A hood assembly according to claim 1, wherein the elastic modulus of the inner layer is lesser than the elastic modulus of the outer layer.

8. A hood assembly according to claim 1, wherein the inner layer has a greater degree of curvature than the outer layer, when no stretching force is being applied to the sheet.

9. A hood assembly according to claim 1, wherein the outer layer has a greater degree of curvature than the inner layer, when no stretching force is being applied to the sheet.

10. A hood assembly according to claim 1, wherein the filler medium includes an airbag.

11. A hood assembly according to claim 1, wherein the filler medium comprises a gel or an oil.

12. A hood assembly according to any one of the preceding claims claim 1, wherein the resilient material comprises rubber.

13. A kit of parts comprising a hood for a protective suit and a seal for fitting about the rim of the hood, wherein the seal comprises a sheet composed partly or entirely of resilient material,
the sheet being provided with a pocket,
the pocket having a first layer, a second layer, and a filler medium disposed between the first and second layers, the filler medium being configured to transmit force from the first layer to the second layer,
the pocket being configured such that:
(i) the first layer is curved about the filler medium when no stretching force is applied to the sheet, and
(ii) as the sheet is subjected to a stretching force:
a first component of the stretching force is transmitted along the first layer, the first component of the stretching force being greater than any component of the stretching force that is simultaneously transmitted along the second layer, and
the curvature of the first layer is reduced, so that a pressing force is transmitted from the first layer, through the filler medium, onto the second layer.

14. A kit of parts comprising:
a hood assembly according to claim 1; and
a respiratory mask,
wherein the seal of the hood assembly is configured to seal the hood assembly about the mask.
